(19) United States
(12) Patent Application Publication
(10) Pub. No.: US 2010/0259230 A1
(43) Pub. Date: Oct. 14, 2010

(54) POWER FACTOR CORRECTION DEVICE WITH ADJUSTABLE CAPACITANCE

(76) Inventor: Howard G. Boothroyd, Nokomis, FL (US)

Correspondence Address: EDWARD M. LIVINGSTON, PA, 963 TRAIL TERRACE DRIVE, NAPLES, FL, 34103, US

(21) Appl. No.: 12/732,296

(22) Filed: Mar. 26, 2010

Related U.S. Application Data
(60) Provisional application No. 61/168,821, filed on Apr. 13, 2009.

(51) Int. Cl. G05F 1/70

(52) U.S. Cl. 323/209

(57) ABSTRACT

A power factor correction device (1) having one or more capacitors (10) in which the capacitance can be varied depending on the amount of power factor correction that is needed for a given application. Disconnect blocks (16) having internal bridging bars (19) are used to activate and deactivate fixed-value capacitors (13) and/or variable capacitance capacitors (12) within the device. The device may use variable capacitance capacitors either alone or in combination with fixed-value capacitors depending on the size of an electrical circuit. In addition to reducing electrical usage by correcting power factor, surge protection is promoted through the use of surge arresters (18).

### CROSS REFERENCE TO RELATED APPLICATION

This application claims the benefit of U.S. Provisional Patent Application No. 61/168,821, filed Apr. 13, 2009. The patent application identified above is incorporated here by reference in its entirety to provide continuity of disclosure.

### BACKGROUND OF THE INVENTION

This invention relates to energy saving devices, more particularly, an energy savings device that corrects power factor in an electrical circuit through the use of variable capacitors that may be adjusted to lower or raise the level of capacitance depending on how much or how little power factor correction is needed in a particular electrical circuit.

In residential or commercial establishments, the loads served by electric utility companies are generally primarily resistive, such as a space heater, or primarily inductive, such as a motor. The inductive loads draw a combination of kilowatts (real or inductive power) and kilovars (reactive power). Capacitors are a static source of kilovars.

Capacitors installed at inductive loads provide a number of benefits: reduced electrical energy consumption, reduced line current, increased voltage at the load, better voltage regulation and lower energy losses. These benefits are accomplished by installing sufficiently sized capacitors at the load to bring power factor to just under unity. Power factor is equal to killowatts divided by kilovars.

Current power factor correction devices use capacitors with fixed levels of capacitance, commonly measured in microfarads (uF). The size of a capacitor to be used in any application is determined at the time of installation. Current fixed-value power factor correction devices do not provide a user with the ability to adjust the level of capacitance when changes in the electrical circuit occur. However, power factor in an electrical circuit may change over time due to the addition or removal of electrical devices from the electrical circuit. In situations such as these, a fixed-value power factor correction device has to be removed from the electrical circuit and replaced with a different unit having the correct fixed capacitance level. The replacement of a fixed-value power factor correction device can be very expensive. For this reason, capacitors are not used to optimize load factor as widely as they might be.

Although there have been attempts to create power factor correction devices having adjustable levels of capacitance in the past, such attempts could not be accomplished manually and required computerization. Past devices used standard on/off switches, on/off buttons, etc. to activate and deactivate fixed-value capacitors and/or variable capacitance capacitors within the device. However, the on/off switches, on/off buttons, etc. could not handle the electrical loads of common single phase or three phase applications and would short out very easily, thereby causing the power factor correction device to be inoperable.

Thus, a need exists for a power factor correction device with adjustable capacitance that allows a user to adjust the level of capacitance of the power factor correction device during installation and when there are changes in the induction load electrical circuit. In addition, a need exists for a power factor correction device having a means for activating and deactivating fixed-value capacitors and/or variable capacitance capacitors within the device that is able to handle electrical loads commonly found in single phase and three phase applications.

The relevant prior art includes the following references:

| Patent No. | | |
|---|---|---|
| (U.S. unless stated otherwise) | Inventor | Issue/Publication Date |
| 2009/0310272 | Howell | Dec. 17, 2009 |
| 3,300,712 | Segsworth | Jan. 24, 1967 |
| 3,859,564 | Zulaski | Jan. 07, 1975 |
| 3,900,772 | Anderl et al. | Aug. 19, 1975 |
| 5,138,519 | Stockman | Aug. 11, 1992 |
| 5,227,962 | Marsh | Jul. 13, 1993 |
| 5,287,288 | Brennen, et al. | Feb. 15, 1994 |
| 5,510,689 | Lipo et al. | Apr. 23, 1996 |
| 5,627,737 | Maekawa et al. | May 06, 1997 |
| 5,638,265 | Gabor | Jun. 10, 1997 |
| 5,793,623 | Kawashima et al. | Aug. 11, 1998 |
| 5,878,584 | Sasaki et al. | Mar. 09, 1999 |
| 6,008,548 | Fenner et al. | Dec. 28, 1999 |
| 6,191,676 | Gabor | Feb. 20, 2001 |
| 2002/0089373 | Shashoua | Jul. 11, 2002 |
| 6,462,492 | Sakamoto et al. | Oct. 08, 2002 |
| 6,573,691 | Ma et al. | Jun. 03, 2003 |
| 6,747,373 | Hu et al. | Jun. 08, 2004 |
| 6,876,178 | Wu et al. | Apr. 05, 2005 |
| 7,092,232 | Yamagata et al. | Aug. 15, 2006 |
| 7,203,053 | Stockman | May 10, 2007 |

### SUMMARY OF THE INVENTION

The primary objects of the present invention are to provide a power factor correction device in which the capacitance level is adjustable.

Another object of the present invention is to provide a power factor correction device having a means for activating and deactivating fixed-value capacitors and/or variable capacitance capacitors within the device is able to handle electrical loads commonly found in single phase and three phase applications.

An even further object of the present invention is to provide a power factor correction device that optimizes power factor in an electrical circuit.

Another object of the present invention is to provide a power factor correction device that reduces kilowatt usage.

An even further object of the present invention is to provide a power factor correction device that provides surge protection.

Another object of the present invention is to provide a power factor correction device that provides brown-out protection.

An even further object of the present invention is to provide a power factor correction device that extends the life span of motors and appliances.

The present invention fulfills the above and other objects by providing a power factor correction device that saves electrical energy by optimizing the power factor in an electrical circuit through the use of capacitors.

Power factor optimization is a technique used to improve the relationship between inductive power and reactive power as follows:

$$power factor ( pf ) = \frac{kilowatts ( working \text{/} real \text{/} inductive power )}{kilovars ( apparent \text{/} total reactive power )}$$

Capacitors are static sources of kilovars or reactive power and can be installed at a circuit breaker box or switch of inductive equipment, such as air conditioner motors, to reduce amperage usage and adjust the power factor as close as possible to unity, i.e., 1. In this manner the equipment is provided only the power necessary to operate optimally. As is typical of energy saving devices, the present device uses capacitors, however, unlike prior devices, the present device uses capacitors in which the capacitance can be varied depending on the amount of power factor correction that is needed for a given application. In addition, the present invention provides a means for activating and deactivating fixed-value capacitors and/or variable capacitance capacitors within the device in which said means is able to handle electrical loads commonly found in single phase and three phase applications. Specifically, the device uses one or more disconnect blocks positioned between one or more capacitors and the electrical circuit. The disconnect blocks each comprise an internal bridging bar that is operable by a locking means for manually connecting or disconnecting a capacitor or portion of a capacitor to or from the electrical circuit. The device may use variable capacitance capacitors either alone or in combination with fixed-value capacitors depending on the size of an electrical circuit.

In addition to reducing electrical usage, surge protection is promoted through the use of surge arresters, also called metal oxide varistors (MOVs) or transient voltage surge suppressors (TVSS) that are located in the power factor correction device. The surge arresters provide surge, lightning, and brown-out protection to the electrical circuit.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front perspective view of the outside of a power factor correction device of the present invention;

FIG. 2 is a front perspective view of the inside of a power factor correction device of the present invention for three phase applications;

FIG. 3 is a front perspective view of the inside of a power factor correction device of the present invention for single phase applications;

FIG. 4 is a perspective side view of a disconnect block of the present invention; and

FIG. 5 is a top view showing discreet capacitive cells of a variable capacitance capacitor.

### DESCRIPTION OF THE PREFERRED EMBODIMENTS

For purposes of describing the preferred embodiment, the terminology used in reference to the numbered components in the drawings is as follows:

| | |
|---|---|
| 1. | device |
| 2. | enclosure |
| 3. | rear wall |
| 4. | side wall |
| 5. | front cover |
| 6. | securing means |
| 7. | knockout hole |
| 8. | on/off status lamp |
| 9. | surge arrester status lamp |
| 10. | capacitor |
| 11. | holding means |
| 12. | variable capacitance capacitor |
| 13. | fixed-value capacitor |
| 14. | din rail |
| 15. | terminal block |
| 16. | disconnect block |
| 17. | circuit breaker |
| 18. | surge arrester |
| 19. | bridging bar |
| 20. | circuit bar |
| 21. | locking means |
| 22. | discreet capacitive cell |
| 23. | individual tap |
| 24. | common terminal |

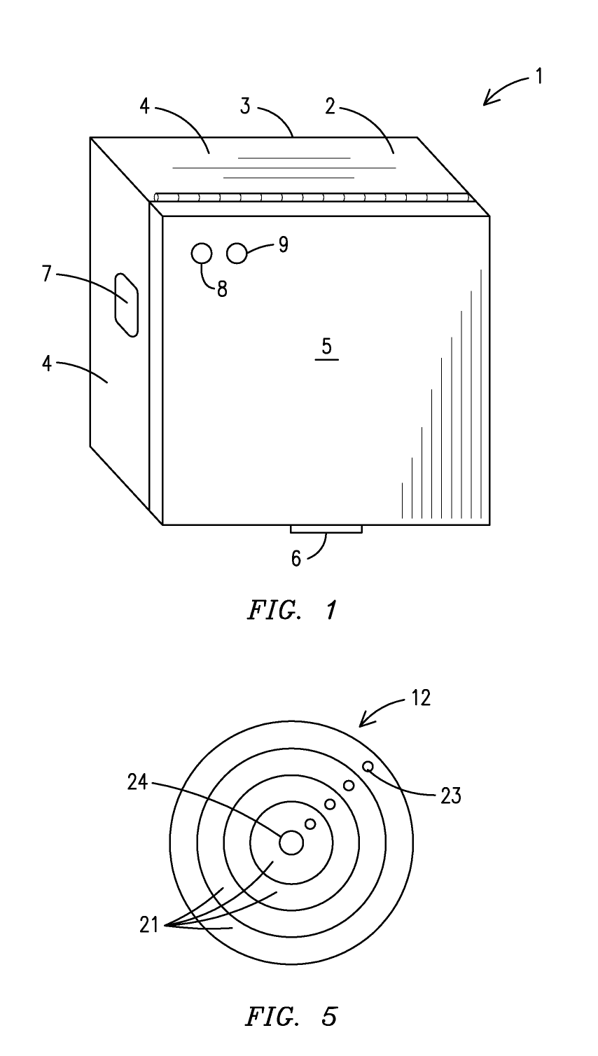

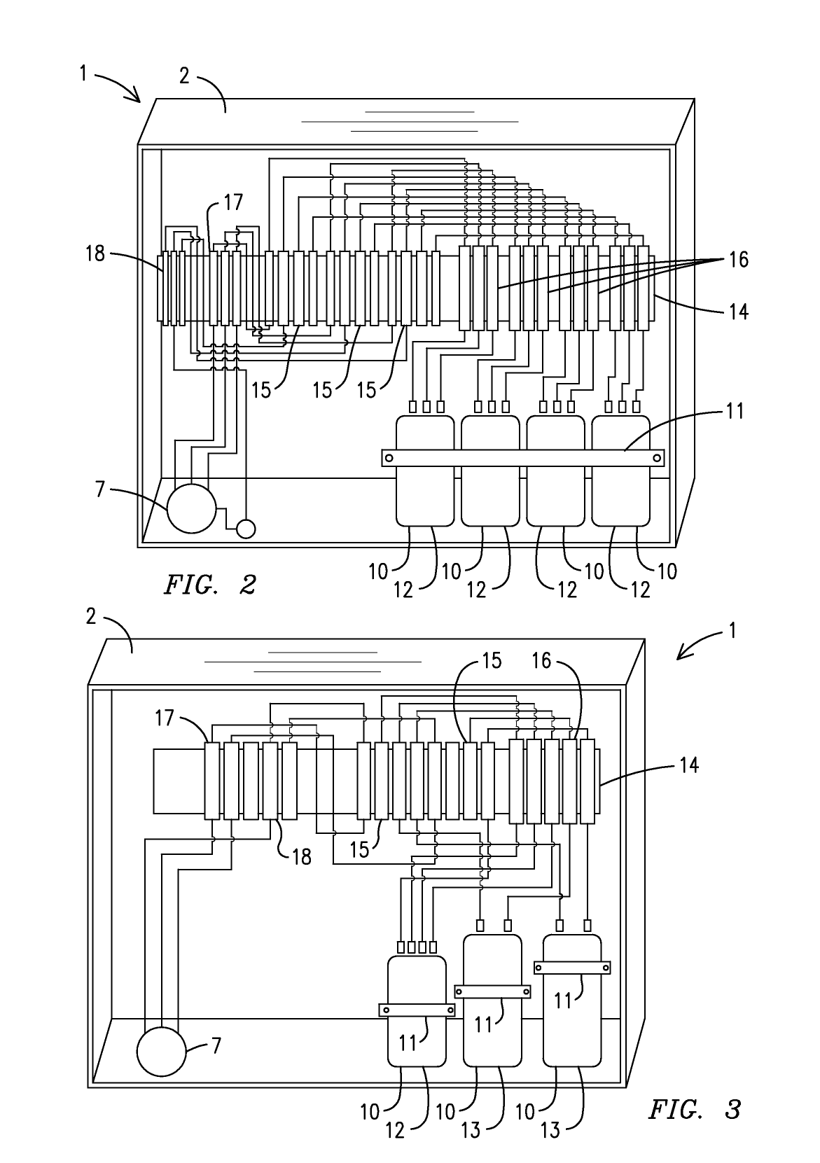

With reference to FIG. 1, a front perspective view of the outside of a power factor correction device 1 of the present invention is shown. The power factor correction device 1 preferably has an outer enclosure 2 having a rear wall 3, side walls 4, a front cover 5, a securing means 6, such as a latch, screw, etc., for securing the front cover 5 to the enclosure 2 and at least one knockout hole 7 for connecting the device to an electrical service, preferably a circuit breaker switch or switch at an electrical panel or meter. An on/off status lamp 8, which is preferably green, located on the enclosure 2 visually indicates to a user that the device is activated when the on/off status lamp 8 is illuminated. Alternatively, the on/off status lamp 8 visually indicates to a user that the device has been deactivated when the on/off status lamp 8 is not illuminated. An surge arrester status lamp 9, which is preferably red, located on the enclosure 2 visually indicates to a user that an at least one surge arrester 18 (as shown in FIGS. 2 and 3) located inside the enclosure 2 has been tripped when the surge arrester status lamp 8 is illuminated.

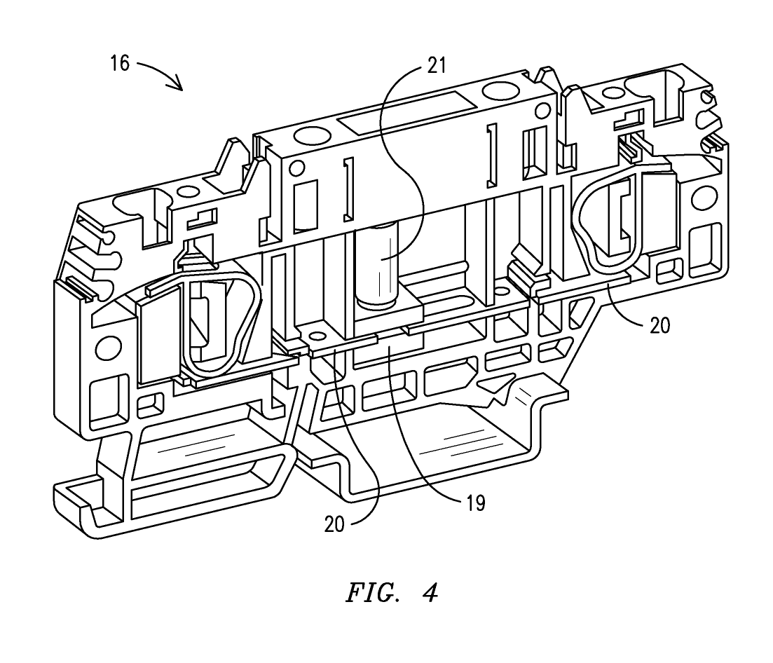

With reference to FIGS. 2 and 3, internal views of power factor correction devices 1 of the present invention for use in a three phase application and a single phase application, respectively, are shown. At least one capacitor 10 is located inside the enclosure 2 and preferably held in place by at least one holding means 11, such as a bracket, nut and bolt, etc. The number and capacitance level of the at least one capacitor 10 depend on the electrical demand of an application and if the application is a single phase or three-phase application. The at least one capacitor 10 may have at least one variable capacitance capacitor 12 or a combination of at least one variable capacitance capacitor 12 and at least one fixed-value capacitor 13 located therein. The type and combination of capacitors 10 depends on the electrical demand of an application. A din rail 14 mounted on the rear wall 3 of the enclosure 2 provides an attachment point for at least one terminal block 15, at least one disconnect block 16, at least one circuit breaker 17 and at least one surge arrester 18. The at least one disconnect block 16 further comprises an internal bridging bar 19 (shown further in FIG. 4) that allows a user to manually activate or deactivate the at least one capacitor 10 or individual discreet capacitive cells 22 of a variable capacitor 12 (shown further in FIG. 5), thereby allowing a user to adjust the capacitance level of the device 1. The at least one terminal block 15 is grouped to provide a point of connection for an electrical circuit from the at least one circuit breaker 17, the at least one disconnect block 16, the at least one capacitor 10 and the at least one surge arrester 18. The at least one circuit breaker 17 allows a user to activate or deactivate the device 2. Surge protection is promoted through the use of the at least one surge arrester 18, also referred to as called metal oxide varistors (MOVs) or transient voltage surge suppressors (TVSS). The at least one surge arrester 18 provide surge, lightning, and brown-out protection to electrical devices that are connected to the same electrical circuit that the power factor correction device 2 is connected to. At least one knockout hole 7 for connecting the device to an electrical service is located on the enclosure 2.

With reference to FIG. 4, a perspective side view of a disconnect block 16 of the present invention is shown. The disconnect block 16 comprises an internal bridging bar 19 that allows a user to manually activate or deactivate the at least one capacitor 10 or individual discreet capacitive cells 22 of a variable capacitance capacitor 12 (shown further in FIG. 5) depending on if a fixed-value capacitor is 13 or an individual discreet capacitive cell 12 is electrically connected to the disconnect block 16. When the bridging bar 19 is in a closed position, as shown here, the bridging bar links two circuit bars 20 together, thereby creating an electrical circuit to a capacitor 10 and increasing the capacitance of the device 2. To terminate the electrical circuit with a capacitor 10, a user simply slides the bridging bar 19 into an open position, thereby breaking the link between the two circuit bars 20 and creating a space between the two circuit bars 20. A locking means 21, such as a screw, allows a user to lock the bridging bar in an open position or a closed position, thereby ensuring that the bridging bar will not accidentally slide from a closed position to an open position or vice versa.

With reference to FIG. 5, a top view of a discreet capacitive cells 21 of a variable capacitance capacitor 12 is shown. The variable capacitance capacitor 12 is made up of multiple separate and discreet capacitive cells 22 each having individual taps 23 and a common terminal 24. Each discreet capacitive cell 22 has a fixed capacitance level. The individual taps 23 allow a user to individually activate and deactivate each discreet capacitive cell 22 through the use of a disconnect blocks 16, as shown in the FIGS. 2-4. For example a variable capacitance capacitor 12 with three multiple discreet capacitive cells 22, one discreet capacitive cell 22 having a capacitance level of twenty microfarads, a second discreet capacitive cell 22 having a capacitance level of forty microfarads and a third discreet capacitive cell 22 having a capacitance level of forty microfarads, may be set using disconnect blocks 16 to capacitance levels of twenty microfarads, forty microfarads, sixty microfarads, eighty microfarads, or one-hundred microfarads.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A power factor correction device comprising:
an enclosure having a rear wall, at least one side wall and a front cover;
at least one capacitor; and
at least one disconnect block in electrical communication with the at least one capacitor for connecting or disconnecting the at least one capacitor to an electrical circuit.

2. The power factor correction device of claim 1 wherein:
said at least one capacitor comprises at least one variable capacitance capacitor having at least two discreet capacitive cells.

3. The power factor correction device of claim 1 wherein:
said at least one capacitor comprises at least one variable capacitance capacitor having at least two discreet capacitive cells; and
said at least one capacitor further comprises at least on fixed-value capacitor.

4. The power factor correction device of claim 1 wherein:
said at least one disconnect block further comprises a bridging bar;
a first circuit bar separated from a second circuit bar; and
said first circuit bar and second circuit bar are connected by moving the bridging bar into a closed position, thereby allowing electricity to flow from the first circuit bar through the bridging bar to the second circuit bar.

5. The power factor correction device of claim 4 wherein:
said at least one disconnect block further comprises a locking means for locking the bridging bar in an open position or a closed position.

6. The power factor correction device of claim 1 further comprising:
at least one terminal block in electrical communication with the at least one capacitor and the at least one disconnect block located within the enclosure.

7. The power factor correction device of claim 1 further comprising:
at least one circuit breaker in electrical communication with the at least one capacitor and the at least one disconnect block located within the enclosure.

8. The power factor correction device of claim 1 further comprising:
at least one surge arrester in electrical communication with the at least one capacitor and the at least one disconnect block located within the enclosure.

9. The power factor correction device of claim 1 further comprising:
an on/off status lamp in electrical communication with the at least one capacitor and the at least one disconnect block located on the enclosure for indicating if the power factor correction device is activated or deactivated.

10. The power factor correction device of claim 8 further comprising:
a surge arrester status lamp in electrical communication with the at least one surge arrester located on the enclosure for indicating if the at least one surge arrester has been tripped.

11. The power factor correction device of claim 1 further comprising:
a din rail located on the rear surface of the enclosure for holding the at least one disconnect block.

12. A power factor correction device comprising:
an enclosure having a rear wall, at least one side wall and a front cover;
at least one capacitor; and
at least one disconnect block in electrical communication with the at least one capacitor for connecting or disconnecting the at least one capacitor to an electrical circuit, said at least one disconnect block further comprising a bridging bar, a first circuit bar separated from a second circuit bar, said first circuit bar and second circuit bar are connected by moving the bridging bar into a closed position, thereby allowing electricity to flow from the first circuit bar through the bridging bar to the second circuit bar.

13. The power factor correction device of claim 12 wherein:
said at least one capacitor comprises at least one variable capacitance capacitor having at least two discreet capacitive cells.

14. The power factor correction device of claim 12 wherein:
said at least one capacitor comprises at least one variable capacitance capacitor having at least two discreet capacitive cells; and
said at least one capacitor further comprises at least one fixed-value capacitor.

15. The power factor correction device of claim 12 wherein:
said at least one disconnect block further comprises a locking means for locking the bridging bar in an open position or a closed position.

16. The power factor correction device of claim 12 further comprising:
at least one terminal block in electrical communication with the at least one capacitor and the at least one disconnect block located within the enclosure.

17. The power factor correction device of claim 12 further comprising:
at least one circuit breaker in electrical communication with the at least one capacitor and the at least one disconnect block located within the enclosure.

18. The power factor correction device of claim 12 further comprising:
at least one surge arrester in electrical communication with the at least one capacitor and the at least one disconnect block located within the enclosure.

19. The power factor correction device of claim 12 further comprising:
an on/off status lamp in electrical communication with the at least one capacitor and the at least one disconnect block located on the enclosure for indicating if the power factor correction device is activated or deactivated.

20. The power factor correction device of claim 18 further comprising:
a surge arrester status lamp in electrical communication with the at least one surge arrester located on the enclosure for indicating if the at least one surge arrester has been tripped.

21. The power factor correction device of claim 12 further comprising:
a din rail located on the rear surface of the enclosure for holding the at least one disconnect block.
